(19) United States
(12) Patent Application Publication
(10) Pub. No.: US 2014/0039906 A1
(43) Pub. Date: Feb. 6, 2014

(54) OPTIMIZED SURGERY SCHEDULING

(71) Applicants: Haiyan Wang, Fremont, CA (US); Cipriano A. Santos, Modesto, CA (US); Enis Kayis, East Palo Alto, CA (US); Shailendra K. Jain, Cupertino, CA (US); Sharad Singhal, Belmont, CA (US); Maria Teresa Gonzalez Diaz, Mountain View, CA (US)

(72) Inventors: Haiyan Wang, Fremont, CA (US); Cipriano A. Santos, Modesto, CA (US); Enis Kayis, East Palo Alto, CA (US); Shailendra K. Jain, Cupertino, CA (US); Sharad Singhal, Belmont, CA (US); Maria Teresa Gonzalez Diaz, Mountain View, CA (US)

(21) Appl. No.: 13/563,575

(22) Filed: Jul. 31, 2012

(51) Int. Cl. G06Q 50/22

(52) U.S. Cl. 705/2

(57) ABSTRACT

Techniques for generating optimized surgery schedules are described in various implementations. In one example implementation, a method that implements the techniques includes receiving a plurality of surgery scheduling requests for surgical procedures to be performed at a surgical facility having a plurality of operating rooms. The method also includes identifying resource constraints associated with the surgery scheduling requests, and identifying an optimization goal for the surgical facility, the optimization goal being defined using weighted optimization parameters. The method also includes generating a proposed surgery schedule for the surgical facility that includes sequencing and operating room assignments for each of the surgical procedures to be performed, the proposed surgery schedule satisfying the resource constraints and being optimized based on the optimization goal for the surgical facility. The method also includes simulating the proposed surgery schedule to determine expected operational metrics associated with the proposed surgery schedule.

### BACKGROUND

Worldwide healthcare costs are currently estimated at $4-5 trillion per year. The United States alone currently spends over $2.5 trillion every year on healthcare, and total spending on healthcare in the U.S. is projected to reach $4 trillion per year by 2015 according to some estimates. Costs associated with surgical facilities represent a significant portion of the overall healthcare spending because surgical facilities typically consume some of the most expensive healthcare resources, such as surgeons, anesthesiologists, surgical equipment, and the like.

Surgical facilities may be located within hospitals or in standalone surgical centers, and may often include multiple operating rooms. Typical surgical facilities may have between three and ten operating rooms, some of which may be specialized operating rooms that are configured for specific types of surgical procedures. In some cases, larger surgical facilities may have upwards of thirty or more general-purpose and/or specialized operating rooms.

### BRIEF DESCRIPTION OF THE DRAWINGS

FIG. 1 is a conceptual diagram of an example surgery scheduling environment.

FIG. 2 is a block diagram of an example surgery scheduling system.

FIG. 3 is a flow diagram of an example process for generating and simulating a proposed surgery schedule.

### DETAILED DESCRIPTION

Many surgical facilities include multiple operating rooms and rely on human administrators to manually schedule surgeries to be performed in their respective operating rooms one or more days in advance. For example, on a daily basis a scheduling coordinator for a surgical suite of a hospital may decide the sequence of surgeries to be performed the next day, as well as the assignment of resources to those surgeries. The resources may include human resources (e.g., anesthesiologists, nurses, and other staff) as well as non-human resources (e.g., surgical equipment, supplies, consumables, and the like). Such sequencing and assigning of resources may be determined by the scheduling coordinator in view of discussions with various individuals or groups of affected personnel, including nurses, anesthesiologists, MRI/CT scheduling coordinators, and the like.

The scheduling process may be very complex, as it typically requires human administrators to manually coordinate many expensive resources (e.g., operating rooms, surgeons, anesthesiologists, nurses, medical equipment, etc.) to ensure that the right resources are available at the right place at the right time. Moreover, uncertainties exist in many phases of surgical operations (e.g., patient arrival times, patient cancellations, unexpected emergency cases, surgery duration, post-anesthesia care unit (PACU) stay duration, etc.), which further complicates the scheduling process. As the number of operating rooms in a surgical facility increase, the complexity of determining an appropriate operating schedule may increase dramatically.

Operating room scheduling may directly or indirectly impact many other resource requirements of a facility, and may therefore influence patient throughput, patient satisfaction, personnel satisfaction, and the facility's bottom line. As such, it may be desirable to not only determine a workable operating schedule on a daily basis, but to intelligently determine an optimized schedule that considers near-term and/or longer-term operational goals of the facility. For example, some surgical facilities may wish to maintain the highest utilization of the facility that also achieves a desired level of patient and personnel satisfaction, while other surgical facilities may wish to place a higher emphasis on patient satisfaction while still achieving a certain level of utilization. These different operational goals may lead to different optimal results for surgical scheduling purposes.

In accordance with the techniques described here, a computer-implemented scheduling system may generate an optimized surgery schedule, e.g., for surgeries to be performed the next day, based on the resource constraints associated with the surgeries to be performed and based on an optimization goal for the surgical facility. In an example implementation, a method may include receiving, at a scheduling system that executes on a processor, a plurality of surgery scheduling requests for surgical procedures to be performed at a surgical facility having a plurality of operating rooms. The method may also include identifying resource constraints associated with the surgery scheduling requests and identifying an optimization goal for the surgical facility, the optimization goal being defined using weighted optimization parameters. The method may also include generating a proposed surgery schedule for the surgical facility that includes sequencing and operating room assignments for each of the surgical procedures to be performed, the proposed surgery schedule satisfying the resource constraints and being optimized based on the optimization goal for the surgical facility. The method may also include simulating the proposed surgery schedule to determine expected operational metrics associated with the proposed surgery schedule. In some implementations, expected variability on these metrics may also be determined and may be presented to a user.

In some cases, the techniques described here may be used to automatically generate an optimized surgery schedule, which may save valuable staff time and may also improve the overall performance of the surgical facility. The optimization models used to generate the optimized surgery schedule may incorporate a broad range of scheduling constraints, and may be tailored to a specific goal of the surgical facility. The proactive capabilities provided by the techniques described here may provide increased objectivity and predictability to the scheduling process. These and other possible benefits and advantages will be apparent from the figures and from the description that follows.

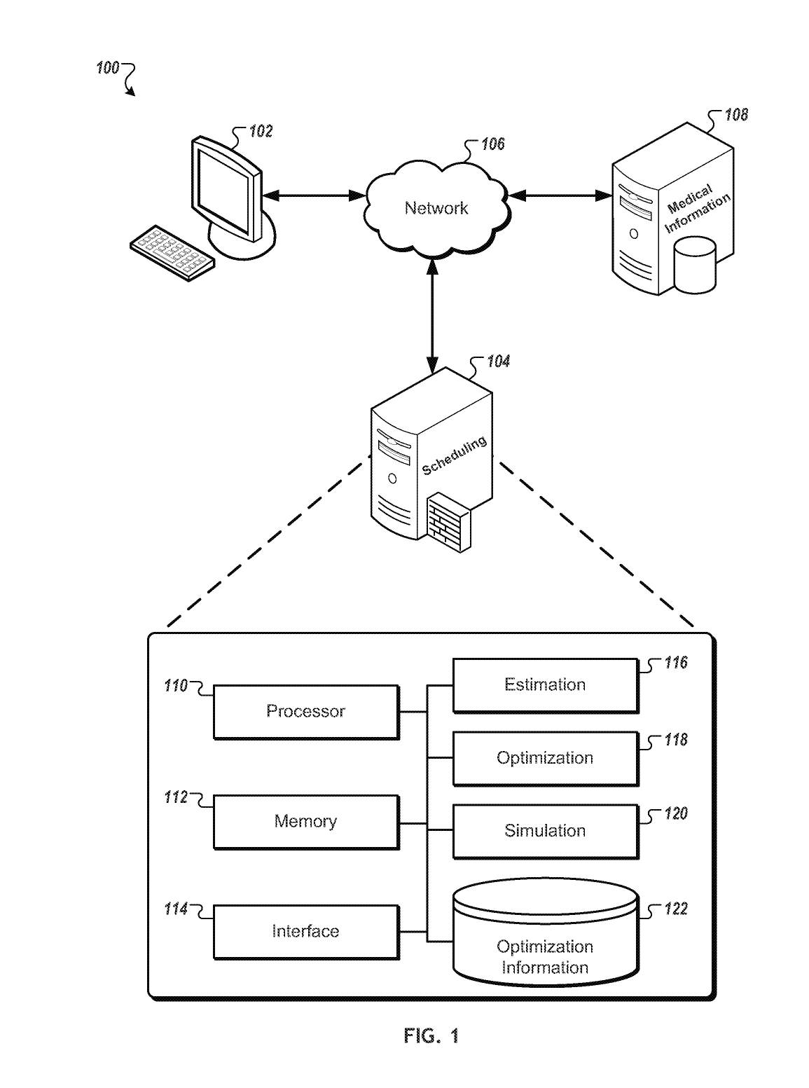

FIG. 1 is a conceptual diagram of an example surgery scheduling environment 100. Environment 100 may be representative of an integrated surgical facility management system, with components of the system being hosted on-site at the surgical facility or off-site at a remote location. Environment 100 includes a computing device 102 in communication with a scheduling system 104 via a network 106. The computing device 102 and the scheduling system 104 may also be in communication with a medical information system 108 via the network 106. Network 106 may be implemented in any appropriate manner, including a local area network (LAN), a wide area network (WAN), the Internet, or another appropriate type of computer network or combination of computer networks.

In operation, the scheduling system 104 may receive, over time, a number of surgery scheduling requests, e.g., via user entry from computing device 102. The surgery scheduling requests may each correspond to a specific surgery to be performed on a particular patient during a particular time period (e.g., on a particular date in the future). In various implementations, the users who may be permitted to submit surgery scheduling requests may include, for example, a surgeon or a surgeon's administrative assistant who may enter a requested date and time that is convenient for the surgeon and the patient, a surgical facility employee who manages scheduling requests from surgeons or patients and inputs the requests into the system, or even a patient who may be allowed to request or select possible surgery dates via an online booking tool.

Prior to a date on which a number of the requested surgeries are to be performed, the scheduling system 104 may generate an optimized proposed surgery schedule that suggests the actual sequence of surgeries to be performed on that date (e.g., the next day) and the assignment of personnel and equipment to the various surgeries. The proposed surgery schedule may be generated such that it satisfies various resource constraints associated with personnel and equipment, and such that it is optimized according to the particular facility's optimization goals. The facility's optimization goals may be configurable, and may include, for example, optimization criteria relating to operating room efficiency, patient satisfaction, and/or other definable optimization criteria.

While example environment 100 is shown as a client-server type of architecture, it should be appreciated that other appropriate configurations of the various components are also within the scope of this disclosure. For example, the scheduling system 104 may be configured to execute locally on computing device 102 rather than being accessed through the network 106. As another example, the scheduling system 104 may be integrated with medical information system 108. In some cases, the functionality being described with respect to a particular component may be performed by one or more different or additional components. Similarly, it should be understood that portions or all of the functionality may be combined into fewer components than are shown.

In the example environment 100, computing device 102 may provide a user interface that allows a user, such as an administrator, to input and/or access electronically stored information associated with the facility, including historical medical data stored by system 108 or scheduling data generated by scheduling system 104. Computing device 102 may represent a laptop, desktop, workstation, smartphone, personal digital assistant, or the like. While only one computing device 102 is shown in environment 100, it should be understood that any appropriate number or types of computing devices may be configured to communicate with scheduling system 104 and/or medical information system 108 as described here. For example, data from scheduling system 104 may be provided to a surgeon or an anesthesiologist via a user interface on their respective mobile computing devices, and may also be provided to a facility administrator via a user interface on a workstation or other computing device located at the facility.

Medical information system 108 may be configured to store or access electronic data associated with patients, surgeons, facility personnel, and/or particular surgical or other medical procedures. For example, system 108 may store or otherwise be configured to access electronic medical records (EMRs) and/or electronic health records (EHRs) associated with individual patients. Similarly, system 108 may store or otherwise be configured to access surgeon/procedure specific historical data that includes, for example, how long particular surgeries or types of surgeries have taken a specific surgeon in the past. System 108 may also store or otherwise be configured to access aggregated surgical data that includes, for example, how long particular surgeries or types of surgeries have taken various surgeons in the past. In some cases, system 108 may also store or otherwise be configured to access other appropriate surgery-related information, such as aggregated or specific post-anesthesia care unit (PACU) stay durations or operating room clean-up and preparation times, or other information that may be utilized by scheduling system 104 to estimate surgery durations and other related scheduling parameters.

In some implementations, medical information system 108 may conform to one or more technical standards associated with EMR/EHR systems. For example, medical information system 108 may be configured to utilize the HL7 standard, which describes message formats for interchanging information between different record systems and practice management systems. As another example, medical information system 108 may be configured to utilize the ANSI X12 (EDI) standard, which describes a set of transaction protocols for transmitting patient data. It should be understood that medical information system 108 may also or alternatively be configured to conform to other standards for EMR/EHR systems.

Scheduling system 104 may be configured to generate an optimized proposed surgery schedule based on the resource constraints associated with the surgeries to be performed during a specified time period (e.g., on a specific date), and on an optimization goal that may be defined by the surgical facility. Scheduling system 104 may also be configured to simulate the optimized proposed surgery schedule to estimate one or more operational metrics that may be expected for the proposed surgery schedule.

The scheduling system 104 may be hosted on, or otherwise implemented by, any appropriate type of computing device, such as a device that includes a processing unit, a system memory, and a system bus that couples the processing unit to the various components of the computing device. The processing unit may include one or more processors, each of which may be in the form of any one of various commercially available processors. Generally, the processors may receive instructions and data stored in a read-only memory and/or a random access memory. The computing device may also include a hard drive, a floppy drive, and/or a disc-based media drive connected to the system bus by respective interfaces. The hard drive, floppy drive, and/or disc-based media drive may access respective non-transitory computer-readable media that provide non-volatile or persistent storage for data, data structures, and computer-executable instructions to perform portions of the functionality described here. Other computer-readable storage devices (e.g., magnetic tape drives, flash memory devices, digital versatile disks, or the like) may also be used with the computing device.

In the example implementation shown, scheduling system 104 includes a processor 110, a memory 112, an interface 114, an estimation engine 116, an optimization engine 118, a simulation engine 120, and a repository 122 to store optimization information. It should be understood that the components shown are for illustrative purposes, and that in some cases, the functionality being described with respect to a particular component may be performed by one or more different or additional components. Similarly, it should be understood that portions or all of the functionality may be combined into fewer components than are shown.

Processor 110 may be configured to process instructions for execution by the scheduling system 104. The instructions may be stored on a non-transitory tangible computer-readable storage medium, such as in memory 112 or on a separate storage device (not shown), or on any other type of volatile or non-volatile memory that stores instructions to cause a programmable processor to perform the techniques described herein. Alternatively or additionally, scheduling system 104 may include dedicated hardware, such as one or more integrated circuits, Application Specific Integrated Circuits (ASICs), Application Specific Special Processors (ASSPs), Field Programmable Gate Arrays (FPGAs), or any combination of the foregoing examples of dedicated hardware, for performing the techniques described herein. In some implementations, multiple processors may be used, as appropriate, along with multiple memories and/or types of memory.

Interface 114 may be implemented in hardware and/or software, and may be configured, for example, to receive and respond to scheduling requests. The scheduling requests may be provided to interface 114, e.g., via a user interface of computing device 102, or from any other appropriate interface. Similarly, outputs from the scheduling system 104 may be provided via interface 114, e.g., to a user interface of computing device 102, or to any other appropriate interface. For example, interface 114 may cause an optimized proposed surgery schedule to be displayed to a user of computing device 102 using appropriate commands. As another example, interface 114 may cause the expected operational metrics associated with the proposed surgery schedule to be displayed to a user of computing device 102 using appropriate commands.

Estimation engine 116 may execute on processor 110, and may be configured to determine estimates of surgery durations based on historical surgical information. The historical surgical information may be stored, for example, on medical information system 108, or in another repository that is accessible by the scheduling system 104. In some cases, the historical surgical information may be extracted from data included in one or more electronic medical records (EMRs).

Estimation engine 116 may perform a hierarchical analysis of available historical data to determine estimates, such as estimates of surgery durations, estimates of PACU stay durations, and the like. For example, if surgeon/procedure specific data is available to determine an estimate of surgery duration, the estimate may be based on the actual times that a specific surgery or type of surgery has taken the surgeon in the past. If the surgeon has not performed that particular procedure or type of procedure, or if the historical duration data is otherwise unavailable, the estimates may be based on procedure specific data associated with other surgeons. For example, in some cases, surgery durations for a particular procedure or type of procedure may be aggregated amongst all surgeons or amongst similarly situated surgeons, and the surgery duration estimate may be based on an average of all or a portion of the actual surgery durations (e.g., the last five surgeries performed). In other cases, surgery duration estimates may be based on upper prediction bounds (e.g., 50th percentile, 75th percentile, or 90th percentile bounds). In other cases, surgery duration estimates may be determined using other appropriate deterministic models applied to the historical data. Estimation engine 116 may also determine probabilistic estimates of surgery duration using appropriate probabilistic models and the available historical duration data.

The estimated surgery durations may then be provided as inputs for schedule optimization and/or for schedule simulation as described below. For example, the estimation engine 116 may provide deterministic estimates of surgery durations to optimization engine 118, and may provide probabilistic estimates of surgery durations to simulation engine 120. In other examples, the deterministic and/or probabilistic estimates of surgery durations may be provided to other or additional components of the scheduling system 104.

Optimization engine 118 may execute on processor 110, and may be configured to generate an optimized proposed surgery schedule that includes sequencing and operating room assignments for each of the surgical procedures to be performed during a given period of time (e.g., over the course of a day). Optimization engine 118 may generate the optimized proposed surgery schedule by solving an optimization problem given the surgical facility's optimization goal, resource availability, resource constraints, and deterministic problem parameters, such as the deterministic estimates of surgery duration. In some implementations, the optimization model may consider uncertainties associated with staffing and resource constraints as well as procedure duration uncertainties to ensure the availability of operating rooms, critical surgical equipment, qualified anesthesiologists, and post-anesthesia care unit (PACU) beds so that patient flow is seamless throughout the entire perioperative process.

Optimization engine 118 may be configured to use different optimization models or different optimization parameters depending on the optimization goal or goals defined for the specific surgical facility. For example, a surgical facility that values staff satisfaction above utilization may use a different optimization model or may weight staff satisfaction higher (indicating a greater relative importance) than a surgical facility that has a goal of increasing utilization to improve the facility's bottom line. In some cases the optimization goal may be defined using a plurality of weighted optimization parameters, with the weighting representing the facility's view of the relative importance of the particular optimization parameters. The different optimization models, optimization parameters, and/or weightings may be configurable by appropriate facility administrators, and may be stored in repository 122 for access by optimization engine 118.

Simulation engine 120 may execute on processor 110, and may be configured to generate estimates of operational metrics that may be expected for a particular optimized proposed surgery schedule. Simulation engine 120 may incorporate the uncertainty of the surgery durations, PACU stays, and other stochastic parameters to test the performance of the optimized schedule under these types of uncertainties, and may also produce estimates of how much variation may be expected in the metrics. These operational metrics and the expected variation (or confidence intervals around the operational metrics) may be displayed to a scheduling coordinator to enable an analysis of the suitability of the proposed schedule.

Some examples of operational metrics that may be used to quantitatively measure the quality or suitability of a particular schedule may include operating room efficiency metrics, such as utilization and total overtime, and/or patient experience metrics, such as on-time starts and patient waiting times. Operating room utilization is defined as the percentage of time used by surgeries during the scheduled operating room opening hours. Total overtime is the sum of overtime beyond the scheduled opening time for all operating rooms in a surgical facility during a given schedule (e.g., over the course of a day). On-time starts is a measure of the cases that are operated on time against the schedule, and patient waiting time is the average time that patients whose surgeries are delayed are forced to wait. In some cases, the operational metrics may include at least one operating room efficiency metric and at least one patient experience metric. Other appropriate metrics, or combinations of metrics, may also be used depending on the particular implementation and the operational metrics and optimization goals that the facility wishes to model.

Such simulations of operational metrics may be used to predict the usage of various facility resources, and may allow facility personnel to plan for anticipated bottlenecks that may occur for a given schedule. The simulations may also be used to quantify the tradeoff between metrics. For example, a facility manager may easily be able to determine how much patient waiting time would increase for a 5% increase in operating room utilization. The facility manager may then make a more informed decision about scheduling. In addition, the scheduling coordinator or facility manager may be able to modify resource inputs based on the simulation results, or to make final scheduling decisions.

In some implementations, the optimized proposed surgery schedule and the simulation results associated with the schedule may be presented to a user, e.g., via an interface on computing device 102, and the user may either accept or reject the proposed schedule. If the user rejects the proposed schedule, e.g., because the confidence intervals indicate a large, potentially risky variance around a particular metric that the user is not willing to accept, or for any other reason, the proposed schedule is discarded, and a new optimized proposed surgery schedule is generated. Based on the feedback of the user, the previous solution (or solutions if the user has rejected multiple proposed schedules) may be excluded as a feasible scheduling option. In some cases, this may be achieved using additional inequality constraints that are added to the optimization models to exclude a rejected schedule. The feedback may also affect certain other constraints applied by the optimization engine (e.g., if the user indicates a particular parameter as being unacceptable). In some implementations similar schedules to the rejected schedules may also be excluded from the set of feasible schedules. The measure of similarity may be configurable, and may be based, e.g., on a specific user definition of similarity or on a degree of similarity that may be defined by the user. Once generated, the new optimized proposed surgery schedule may then be presented to the user along with the simulation results and confidence intervals around the metrics, and the cycle may be repeated until a proposed schedule is accepted by the user.

In some implementations, the scheduling system 104 may accept a partial surgery schedule that is already defined, e.g., based on previous scheduling processes that have already been completed. In such cases, the scheduling system 104 may optimize any unscheduled surgeries that are not defined in the partial schedule to generate a complete optimized surgery schedule. The optimization models for optimizing a partially defined schedule may use fixed decision variables associated with the defined partial surgery schedule (e.g., to ensure that those procedures are not affected). As with the optimized surgery schedules described above, such optimized surgery schedules may be simulated to evaluate the schedule's performance under uncertainty.

Example Optimization Scenarios

As described above, a surgical facility may have different priorities, preferences, and/or goals when determining a surgery schedule. In the examples provided below, three different emphases are considered: 1) improve on-time starts; 2) minimize total overtime; and 3) level PACU workload. It should be understood that the examples shown are for illustrative purposes, and that other appropriate models may also be used in accordance with the techniques described here.

Example Scenario 1: Improve On-Time Starts

Uncertain procedure duration is one of the main reasons that surgeries may be postponed. The main emphasis in this scenario is that procedures assigned in the same room may be sequenced in increasing order of duration variance. In other words, procedures with lower variance will be operated earlier. This is motivated by the fact that earlier procedures may affect all the later procedures. As such, if procedures with higher uncertainties are operated earlier, then there is a higher chance that all later procedures will be affected. In some implementations, the models described in this example may be used to generate relatively efficient scheduling solutions while improving on time starts by making use of historical data.

In this example, the sequencing of surgeries may be implemented using an optimization model as described below. In addition to the sequencing rule to improve on-time starts, bin-packing may also be used to assign procedures to available operating rooms to improve operating room utilization. Most surgeries can be operated in any operating room, while certain specialties of procedures may require special room setup or equipment (e.g., cardiac surgery, eye surgery, etc.). Bin-packing takes advantage of this flexibility to assign the surgical procedures into operating rooms so that they may be used more efficiently.

While taking advantage of room flexibility, the same surgeon's procedures may be allocated to different operating rooms. It must be ensured that there is no overlap between procedures of the same surgeon. Therefore, room assignment for each procedure and sequencing of procedures within a room may be optimized simultaneously.

In most situations, the number of rooms that require a certain anesthesia specialty (e.g., cardiac versus general) does not exceed the number of available anesthesiologists of that specialty. The list of anesthesiologists available may be ranked in the sense that the person who is on the first call should be responsible for the longest time (e.g., 24 hours), while the second or third call person may be responsible for a shorter time (e.g., 13 hours), and others may be off even earlier. Therefore, after all the procedures are assigned to rooms, another optimization model may be used to assign a room with heavier workload to the anesthesiologist with higher rank on the call list.

The scheduling and planning decisions for surgeries to be operated may be addressed in two stages. At the first stage, surgeries may be assigned to the allowed rooms and the procedures within each room may be sequenced in the increasing order of duration variance in each room as much as possible (note that, due to surgeon availability constraint, the rank of procedure may not be exactly in the increasing order of duration variance). At the second stage, anesthesiologists may be assigned to operating rooms.

In the models, i and j may be used as procedure indices; r and r′ as operating room indices, p and p′ as procedure ranks in an operating room (e.g., the first procedure, the second procedure etc.), sur as a surgeon index, Pₛᵤᵣ as the set of procedures that will be operated by surgeon sur, a as an anesthesiology specialty (e.g., either Cardiac or General), and q as equipment type. A number of parameters may be used in the models, including, for example: Dᵢ as the estimated duration of procedure i; STᵢ as the estimated setup time for procedure i; CLᵢ as the estimated clean up time for procedure i; Vᵢ as the variance of duration for procedure i; IRᵢ^{r} as an indicator parameter where 1 means that procedure i can be operated in room r, else 0; IAᵢ^{a} as an indicator parameter where 1 means that procedure i requires an anesthesiologist with specialty a; TRᵣ as the scheduled opening time for room r; cᵤ as the operating room underutilized cost per period; cₒ as the operating room overtime cost per period; and a as the weight parameter associated with the objective term related with sequencing procedures within an operating room.

The following description represents a room assignment and sequencing model (Model_AssSeq) that balances the operating room opening costs and overtime costs and to sequence procedures within a room in increasing order of duration variance as much as possible. In the model, decision variables may be defined as follows: xSᵢ^{r,p} is 1 if procedure i is ranked as the p^{th} procedure in room r, else 0; yᵣ is 1 if room r is open, else 0; utᵣ is the underutilized time of room r, and otᵣ is the overtime of room r; bᵢ is the starting time of procedure i; and zᵢⱼ^{sur} may define the precedence relationship between two procedures of the same surgeon and is 1 if both procedure i and procedure j will be operated by surgeon sur and procedure i is operated before procedure j, else 0.

An objective function of the model may include two considerations: one relating to room total underutilized cost and overtime cost, the other relating to procedure sequencing. To sequence (or rank) the procedures in each room in order of variance, each procedure may be assigned a normalized weight (1−Vᵢ/ΣᵢVᵢ), where Vᵢ is the variance of duration for procedure i. That is, procedures with smaller variance will have larger weights and hence will be ranked earlier by the optimization problem. The model may include a constraint set that requires all procedures be assigned to a room, and another constraint set that requires, for each rank in a room, at most one procedure is assigned. In another constraint set, if rank (p+1) in a room is assigned to a procedure, then rank p must be also assigned to another procedure. Another example constraint set may require that each procedure be assigned to an open and appropriate room. Another constraint set may be used to define the underutilized time and overtime for each room. The model may also include constraint sets that ensure that, for each pair of the same surgeon's procedures, one of the precedence relationship variables is 1, while another constraint set may fix the precedence relationship variable for different surgeon's procedures to be 0. Other constraint sets may define the starting time for each procedure, and may ensure that the gap of starting times between two procedures of the same surgeon must be not less than the duration of the earlier procedure.

To sequence (or rank) the procedures in each room in order of duration (shorter procedures first), the objective function may be modified such that in the item related with sequencing, the normalized weight of each procedure is (1−Dᵢ/ΣᵢDᵢ), where Dᵢ is the estimated duration of procedure i. The rationale of this heuristic is twofold. First, shorter procedures generally have lower variance. Second, fasting is often needed starting from midnight before the day of surgery. As such, scheduling shorter procedures first may reduce total patient fasting time.

At the second stage, anesthesiologists may be assigned to operating rooms. As described above, it may be desirable to assign heavier rooms to anesthesiologists with higher rank on the call list, which may be implemented through the following example anesthesiologist assignment model. In addition, the anesthesia specialty requirement must be satisfied. In the example model below, it is assumed that cardiac anesthesiologists can serve any procedure while general anesthesiologists can only serve non-cardiac procedures. That is, if there is at least one cardiac procedure assigned to a room, the room must be served by a cardiac anesthesiologist, and a general anesthesiologist can only be assigned to a room without any cardiac procedures.

The model may include appropriate parameters, including for example, anes as the index for anesthesiologists; rank(anes) as the rank of an anesthesiologist on the call list; RAnes(r, anes) is 1 if anes can be assigned to room r, else 0; com(r) as the expected completion time of room r; yᵣ as the optimal solution of Model_AssSeq described above; and decision variable yARᵣ^{anes} is 1 if anes is assigned to room r. In the example model, an objective function may ensure that a heavier room is assigned to an anesthesiologist with higher rank on the call list. The model may include constraint sets that ensure every open room is assigned an anesthesiologist; require that an anesthesiologist is assigned to at most one room; and satisfy anesthesia specialty requirements.

Example Scenario 2: Minimize Total Overtime

A second example optimization model may be particularly useful when shared resources are relatively limited. A primary goal of this model is to ensure that required resources are available when a procedure starts, while keeping the overtime costs as low as possible. The optimization model may be based on Mixed Integer Programming (MIP). The operating room open time horizon (e.g., a day or 10 hours) is divided into small time periods (e.g., 5 minutes), and procedures can be scheduled to start at the beginning of any time period. The main decision variables of the MIP model are binary variables that determine if a procedure starts in an operating room at the beginning of a time period. The objective function is to minimize the total overtime across all operating rooms of the surgical facility.

In the model (Model_Opt), a number of appropriate parameters may be used. For example, t=1, 2, . . . , T may represent a time period (e.g., 5 minutes); NAₜ^{a} as the number of anesthesiologists with specialty a during period t; NQ_{q} as the number of equipment type q; NPA as the number of staffed PACU beds available; QT_{r,i}^{q} as the equipment cleaning time after used in procedure i; IQᵢ^{q} as an indicator parameter where 1 means that procedure i needs equipment q, else 0; PACUᵢ as the estimated time that patient i will stay in PACU after the surgery; IPAᵢ as an indicator parameter where 1 means that the patient needs to stay in PACU after the surgery, else 0; and ISur^{sur}ᵢ as an indicator parameter where 1 means that procedure i will be operated by surgeon sur. The model may also include the following decision variables: x_{i,t}^{r} is 1 if procedure i starts at the beginning of period t in room r; Cᵣ is the completion time of room r; otᵣ is the overtime in room r. In this model, it may be assumed that anesthesiologists stay with patients from procedure setup until the patient gets out of the operating room (e.g., before room clean up), and that equipment must be cleaned before it is used in another procedure.

The objective function of the model may be to minimize the total overtime. In the model a constraint set may require that each procedure must be assigned to a room starting at some period. Another constraint set may require that each procedure must be assigned an allowed room. Another constraint set may ensure that there is no overlap among procedures at any time in any room. Other constraint sets may define the completion time of each room, and the overtime based on completion time in each room. Another constraint set may ensure that, at any time, the required number of anesthesiologists with specialty a does not exceed the number of anesthesiologists available at that time period. Because of shift schedule, the number of anesthesiologists varies over a day. Other constraint sets may ensure that the equipment and PACU bed, respectively, are available when needed. Another constraint set may ensure surgeon availability when procedures of the same surgeon are assigned to different rooms. Note that in this model, room flexibility is incorporated as procedures are not required to be operated in a specific room.

Example Scenario 3: Level PACU Workload

Balanced or level PACU workload may typically reduce the potential risk of holding patients in an operating room due to the lack of staffed and available PACU beds. It may also provide improved management of the PACU nurses' workload. In this example scenario, two models are described that address the issue of leveling the PACU workload. In the first model, in addition to the objective of minimizing the total overtime costs, the deviation of number of patients in the PACU in each time period from the average number of patients in the PACU is minimized so that the peak number of patients in the PACU can be controlled. In the second model, the arrival process to the PACU (i.e., the departure process of operating rooms) is controlled such that the inflow of patients to the PACU is as smooth as possible.

Note that the expected average number of patients in the PACU every period may be independent of the arrival sequence because the total expected PACU stay time among all patients is fixed. This assumption is used to determine the deviation of number of patients in the PACU in each period from the average value in the first model. In this model (Model_PACU1), both the total operating room overtime and deviations of number of patients in the PACU in each period from the average number of patients in the PACU are minimized. It may be assumed that the weights associated with the operating room overtime and deviations of the number of patients in the PACU are α1 and α2. This model has similar structure as Model_Opt described in Example Scenario 2 with additional decision variables and constraints. The additional decision variables are as follows: opₜ is the overage of the number of patients in the PACU in period t compared with avePACU; and upₜ is the underage of the number of patients in the PACU in period t compared with avePACU.

The objective function here may be to minimize two measures, one for the operating rooms and the other for the PACU. Model_PACU1 may have similar constraints as in Model_Opt, and a constraint set may define the overage and underage of number of patients in the PACU compared with the average number of patients in the PACU.

In the second model (Model_PACU2), the goal is to have a smooth inflow of patients to the PACU. That is, the model minimizes the total overtime cost while controlling the number of patients entering the PACU during each period with certain length (e.g., 20 minutes). To facilitate modeling, binary decision variables are used to define whether a procedure ends at the end of a period in an operating room. For example, a decision variable z_{i,t}^{r} is 1 if procedure i ends at period t in room r; An additional set of constraints that control the inflow process to the PACU is also described below.

In this model, the total operating room overtime is minimized while controlling the inflow to the PACU. In an example model, constraint sets may ensure that every procedure is scheduled, and that procedures are assigned to an allowed room. Another constraint set may ensure there is no overlap among procedures at any time in any room. Other constraint sets may define the completion time and overtime of room r, respectively. Another constraint set may ensure that anesthesiologists are available when procedures start. Another constraint set may ensure surgeon availability. Another constraint set may require that there is at most one patient entering PACU in every period (e.g., every 20 minutes).

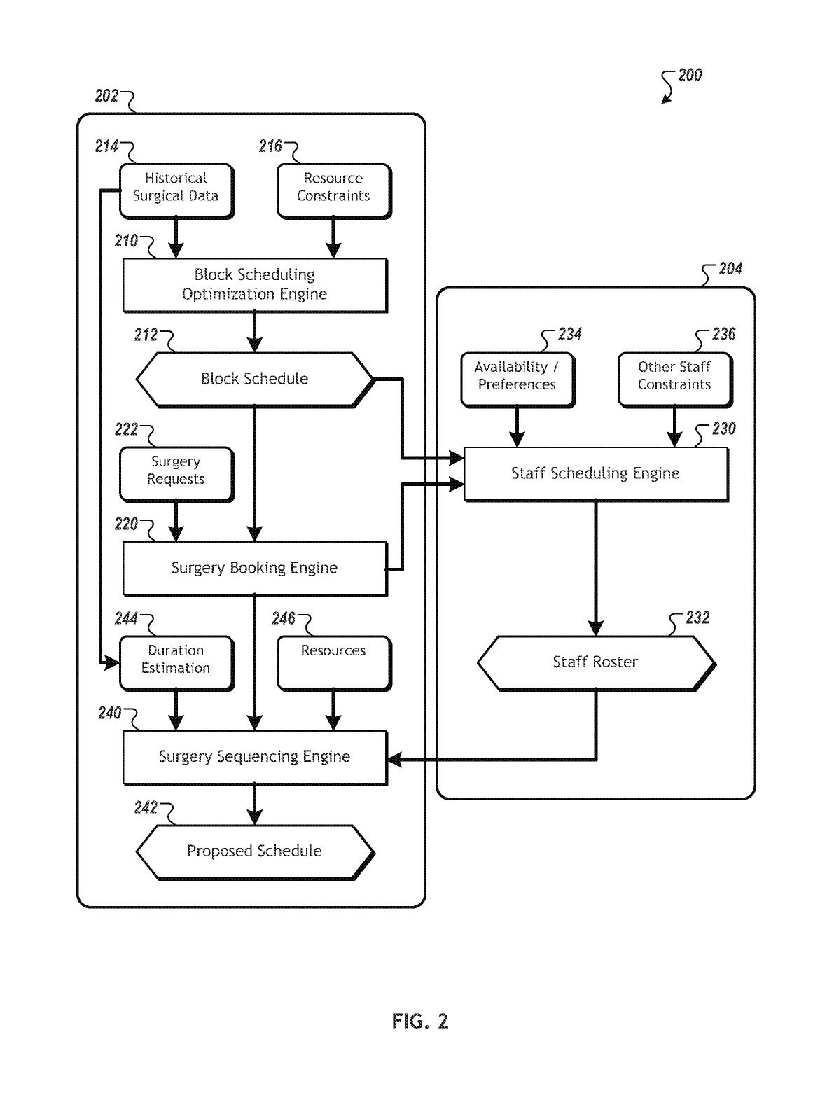

FIG. 2 is a block diagram of an example surgery scheduling system 200. Scheduling system 200 may be implemented as two integrated scheduling systems—a patient scheduling system 202 and staff scheduling system 204. Scheduling system 200 includes four optimization engines—block scheduling optimization engine 210, surgery booking engine 220, staff scheduling engine 230, and surgery sequencing engine 240. Each of the optimization engines may be based on one or more configurable optimization models. For example, surgery sequencing engine 240 may implement one or more of the optimization models discussed above with respect to FIG. 1.

Block scheduling optimization engine 210 may be configured to generate a cyclic table called a block schedule 212. The block schedule 212 may effectively allocate blocks of operating room time to different surgical specialties, such as cardiology or neurology, or to general surgery. The block schedule 212 may also define how many hours a particular room will be open on each day of a given cycle. The cycle length of a block schedule may be configurable, and may typically be configured as multiple weeks or months (e.g., two weeks, four weeks, eight weeks, etc.), and the block schedule may be repeated for a period of time, such as for six months or a year, before being reevaluated.

The block scheduling optimization models may be based on historical surgical data 214 and/or resource constraints 216. The historical surgical data 214 may be retrieved from an EMR system in a hospital or from another appropriate medical information system, and may be used to project the potential demand in terms of total operating hours for each surgical specialty during a given block period. The resource constraints 216 may include, for example, operating room open time, surgeon schedules, and other resources, such as room compatibility, anesthesiologist specialties, PACU beds, and the like. The block scheduling optimization models may also consider emergency cases that are inherently unpredictable, but that may need to be modeled or estimated using appropriate techniques. For example, the block scheduling optimization models may consider emergency operation patterns over time and according to various parameters, and may include an appropriate amount of leeway in the block schedule 212 such that the surgical facility will be able to handle and even predict expected emergency cases.

Surgery booking engine 220 is used to allocate incoming surgery requests 222 to appropriate operating room blocks. Engine 220 may operate on an on-going basis, with lead times for surgery requests ranging from several months to several days in advance of the requested time slot. The block schedule 212 may serve as guidance to the surgery booking engine 220 for allocation of cases at the surgery specialty level. The booking engine 220 may utilize intelligent bin packing procedures to increase or maximize operating room utilization.

The output of surgery booking engine 220 (e.g., an allocation of surgery requests to operating room blocks) and the block schedule 212 may be provided as inputs to staff scheduling engine 230. Staff scheduling may be performed in parallel with the block scheduling and surgery booking demand management processes. Staff scheduling engine 230 may be used to generate a periodic (e.g., monthly) staff roster 232, which may include daily scheduling for entire surgical facility staffs, or for certain types of personnel. For example, in some cases staff scheduling engine 230 may primarily be used to generate a monthly roster for anesthesiologists because their time is especially costly in relation to other staff members. The staff scheduling engine 230 may generate a list of on-call staff for each day of the period (e.g., for the next month).

Staff scheduling engine 230 may use information from block schedule 212 to estimate the demand for each specialty of anesthesiologists because the block schedule specifies which surgical specialty has priority to use each operating room block. Similarly, any previously scheduled surgeries for the next month identified by information from the surgery booking engine 220 may also be used to fine-tune the estimated overall demand for anesthesiologists or other appropriate staff. In addition to these inputs, staff scheduling engine 230 models may also consider staff availability and preferences 234 (e.g., time-off requests, or scheduling preferences). The models implemented by staff scheduling engine 230 may also be configured to consider shift rules and/or other staff constraints 236. These staff constraints 236 may ensure the safety of both staff and patients, and may be intended to improve staff satisfaction. One example of a shift rule staff constraint is that the first call anesthesiologist must be off for the next day following the shift.

Surgery sequencing engine 240 may be configured to generate a proposed schedule 242 that includes the sequence and assignment of resources for surgeries to be performed, e.g., on a given day. The functionality of the surgery sequencing engine 240 is described in greater detail above with respect to scheduling system 104. For example, on a daily basis the surgery sequencing engine 240 may generate the proposed schedule 242 for procedures to be performed the next day.

At the time decision epoch, e.g., a day before the surgery, the elective (i.e., non-emergent) surgeries that will be operated the next day have already been determined by the surgery booking engine 220, and the call list of anesthesiologists may be available from the staff scheduling engine 230. However, the actual procedure duration and other stochastic parameters (e.g., patient arrival times, cancellations, etc.) may be unknown. As such, the scheduling system may use historical surgical data 214 to determine surgery duration estimates 244 as inputs to the scheduling optimization and simulation models implemented by the surgery sequencing engine 240. In the optimization models, staffing and resource constraints 246 are also considered to ensure the availability of operating rooms, critical surgical equipment, anesthesiologists, and PACU beds.

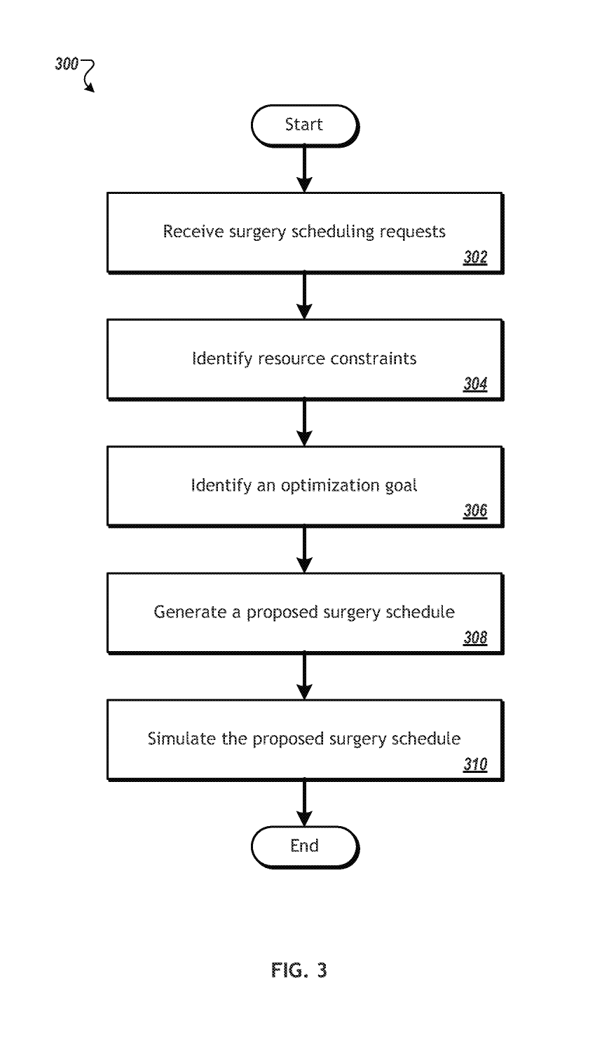

FIG. 3 is a flow diagram of an example process 300 for generating and simulating a proposed surgery schedule. The process 300 may be performed, for example, by a scheduling system such as the system 104 illustrated in FIG. 1. For clarity of presentation, the description that follows uses the scheduling system illustrated in FIG. 1 as the basis of an example for describing the process. However, another system, or combination of systems, may be used to perform the process or various portions of the process.

Process 300 begins at block 302, in which surgery scheduling requests are received. The surgery scheduling requests may each correspond to a specific surgery to be performed on a particular patient during a particular time period (e.g., on a particular date in the future). In various implementations, the users who may be permitted to submit the surgery scheduling requests may include, for example, a surgeon or a surgeon's administrative assistant who enters a requested date and time that is convenient for the surgeon and the patient, a surgical facility employee who manages scheduling requests from surgeons or patients, or even a patient who may select possible surgery dates via an online booking tool.

At block 304, resource constraints associated with the surgery scheduling requests are identified. For example, if the surgery scheduling request relates to a cardiac surgical procedure, certain specialized resources (e.g., specialized cardiac equipment, a cardiac anesthesiologist, etc.) may be required for the surgery.

At block 306, an optimization goal for the surgical facility may be identified. In some implementations, the optimization goal may be expressed as weighted optimization parameters. For example, when more than one optimization parameter may be used to define the overall optimization goal of a facility, the optimization parameters may be weighted based on their relative importance to the facility's management. In some cases, the optimization goals may be configurable, and may include, for example, optimization criteria relating to operating room efficiency, patient satisfaction, and/or other definable optimization criteria.

At block 308, a proposed surgery schedule is generated. The proposed surgery schedule may include sequencing and operating room assignments for each of the surgical procedures to be performed. The proposed surgery schedule may be generated in a manner such that the schedule satisfies the identified resource constraints (e.g., personnel, equipment, etc.) and is optimized based on the optimization goal for the surgical facility.

At block 310, the proposed surgery schedule is simulated to determine expected operational metrics associated with the proposed surgery schedule. In some implementations, the operational metrics may include, e.g., one or more operating room efficiency metrics, such as utilization and total operating room overtime, and/or one or more patient experience metrics, such as on-time starts and patient waiting time. Simulating the proposed surgery schedule may include estimating surgery durations and variances for the surgical procedures to be performed based on historical surgery data. Simulating the proposed surgery schedule may also include estimating post-anesthesia care unit (PACU) stay durations for the surgical procedures to be performed based on historical PACU data.

In some implementations, a feedback loop may be added from block 310 back to block 308. In such cases, the proposed surgery schedule and the simulation results associated with the schedule may be presented to a user, and the user may either accept or reject the proposed schedule. If the user rejects the proposed schedule, the proposed schedule may be discarded, and a new optimized proposed surgery schedule may generated. Based on the feedback of the user, the previous solution (or solutions if the user has rejected multiple proposed schedules) may be excluded as a feasible scheduling option, e.g., by adding inequality constraints to the optimization models to exclude a rejected schedule. In some cases, similar schedules to the rejected schedules may also be excluded from the set of feasible schedules as described above. Once generated, the new optimized proposed surgery schedule may be simulated and may be presented to the user along with the simulation results and confidence intervals around the metrics. The feedback cycle may then be repeated until a proposed schedule is accepted by the user.

Although a few implementations have been described in detail above, other modifications are possible. For example, the logic flows depicted in the figures may not require the particular order shown, or sequential order, to achieve desirable results. In addition, other steps may be provided, or steps may be eliminated, from the described flows. Similarly, other components may be added to, or removed from, the described systems. Accordingly, other implementations are within the scope of the following claims.

What is claimed is:

1. A method comprising:
receiving, at a scheduling system that executes on a processor, a plurality of surgery scheduling requests for surgical procedures to be performed at a surgical facility having a plurality of operating rooms;
identifying, using the scheduling system, resource constraints associated with the surgery scheduling requests;
identifying, using the scheduling system, an optimization goal for the surgical facility, the optimization goal being defined using weighted optimization parameters;
generating, using the scheduling system, a proposed surgery schedule for the surgical facility that includes sequencing and operating room assignments for each of the surgical procedures to be performed, the proposed surgery schedule satisfying the resource constraints and being optimized based on the optimization goal for the surgical facility; and
simulating the proposed surgery schedule to determine expected operational metrics associated with the proposed surgery schedule.

2. The method of claim 1, wherein the operational metrics include at least one efficiency metric and at least one patient experience metric.

3. The method of claim 2, wherein the at least one efficiency metric includes at least one of operating room utilization and total operating room overtime, and the at least one patient experience metric includes at least one of on-time starts and patient waiting time.

4. The method of claim 1, wherein simulating the proposed surgery schedule further comprises determining variances associated with the operational metrics.

5. The method of claim 1, wherein the proposed surgery schedule is optimized based on deterministic estimates of surgery durations for the surgical procedures to be performed, and wherein the proposed surgery schedule is simulated based on probabilistic estimates of surgery durations for the surgical procedures to be performed.

6. The method of claim 1, wherein simulating the proposed surgery schedule comprises determining estimated post-anesthesia care unit (PACU) stay durations for the surgical procedures to be performed, the estimated PACU stay durations being based on historical PACU data.

7. The method of claim 1, wherein the proposed surgery schedule further includes staff assignments for each of the surgical procedures to be performed.

8. The method of claim 1, further comprising, in response to a user indicating rejection of the proposed surgery schedule, generating an alternate proposed surgery schedule that is different from the proposed surgery schedule, the alternate proposed surgery schedule satisfying the resource constraints and being optimized based on the optimization goal for the surgical facility and infeasibility of the proposed surgery schedule.

9. The method of claim 8, wherein the proposed surgery schedule and other similar surgery schedules are excluded as infeasible alternate proposed surgery schedules.

10. A surgery scheduling system comprising:
one or more processors;
an estimation engine executing on at least one of the one or more processors to generate estimates of surgery durations based on past surgical information;
an optimization engine executing on at least one of the one or more processors to generate an optimized surgery schedule that includes sequencing and resource assignments for each of a plurality of surgeries to be performed during a time period, the optimized surgery schedule being generated based on an optimization goal, resource availability, resource constraints, and the estimates of surgery durations; and
a simulation engine executing on at least one of the one or more processors to estimate metrics associated with the optimized surgery schedule.

11. The system of claim 10, wherein the metrics include at least one efficiency metric and at least one patient experience metric.

12. The system of claim 11, wherein the at least one efficiency metric includes at least one of operating room utilization and total operating room overtime, and the at least one patient experience metric includes at least one of on-time starts and patient waiting time.

13. The system of claim 10, wherein the simulation engine determines variances associated with the metrics.

14. The system of claim 10, wherein the estimation engine generates deterministic estimates of surgery durations and probabilistic estimates of surgery durations, and wherein the optimization engine uses the deterministic estimates to generate the optimized surgery schedule and the simulation engine uses the probabilistic estimates to simulate the optimized surgery schedule.

15. The system of claim 10, wherein the optimization engine, in response to an indication of rejection of the optimized surgery schedule, generates an alternate schedule that is different from the optimized surgery schedule, the alternate schedule being generated based on the optimization goal, resource availability, resource constraints, the determined estimates of surgery durations, and infeasibility of the optimized surgery schedule.

16. The system of claim 15, wherein the optimization engine excludes as infeasible the optimized surgery schedule and other similar surgery schedules.

17. The system of claim 10, wherein the estimation engine determines estimates of post-anesthesia care unit (PACU) stay durations based on past PACU data.

18. A non-transitory computer-readable storage medium storing instructions that, when executed by a processor, cause the processor to:
receive surgery scheduling requests for surgical procedures to be performed at a surgical facility;
identify resource constraints associated with the surgery scheduling requests;
identify an optimization goal for the surgical facility, the optimization goal being defined using weighted optimization parameters;
generate a proposed surgery schedule for the surgical facility that includes sequencing and operating room assignments for each of the surgical procedures to be performed, the proposed surgery schedule satisfying the resource constraints and being optimized based on the optimization goal for the surgical facility; and
simulate the proposed surgery schedule to determine expected operational metrics associated with the proposed surgery schedule.
